(19) United States
(12) Patent Application Publication
(10) Pub. No.: US 2026/0329608 A1
(43) Pub. Date: Oct. 22, 2026

(54) SMARTORG AUTOFIX INSIGHT ENGINE TO PROVIDE SOLUTIONS FOR CUSTOMERS

(71) Applicant: Salesforce, Inc., San Francisco, CA (US)

(72) Inventors: Saurabh Gupta, San Francisco, CA (US); Suresh Gupta, Vancouver (CA); Tanmay Padhi, San Francisco, CA (US)

(73) Assignee: Salesforce, Inc., San Francisco, CA (US)

(21) Appl. No.: 19/186,423

(22) Filed: Apr. 22, 2025

(51) Int. Cl. G06F 9/451

(52) U.S. Cl. CPC G06F 9/453

(57) ABSTRACT

A method for providing solutions to a user request, the method comprising: processing a user request identifying an assigned topic, wherein the user request is received from a remote graphical user interface (GUI) coupled to the processor, determining, by an updater coupled to the processor, a plurality of solutions to address the user request with the assigned topic, wherein the plurality of solutions are also determined based on recurring patterns associated with the user request with the assigned topic, transmitting, by the processor, the plurality of solutions received from the updater to the GUI, and identifying, by the processor, a resolution effectiveness of the plurality of solutions applied on the GUI.

### TECHNICAL FIELD

One or more implementations relate to a backend processor identifying and providing efficient and accurate solutions for resolving user requests occurring at the front end of a system. The invention relates to an artificial intelligence (AI) driven troubleshooting system that leverages machine learning (ML), natural language processing (NLP), and dynamic knowledge bases to deliver automated and context specific solutions for user reported issues in real-time.

### BACKGROUND

Currently, users may not have as much no direct or real-time access to tools or resources that could help them resolve problems immediately. Moreover, users in many environments often may face delays when troubleshooting issues due to reliance on static knowledge bases or manual interventions. Existing solutions can direct users to generic help articles that while useful, may lack context-specific and real-time solutions. Instead, the users may navigate either help documentation or multiple layers of support which can often involves submitting tickets, waiting for responses, and escalating issues based on severity. This multi-step process can be more efficient with respect to issue resolution. At the point in which the users first report a problem or issue with a user request, the process can be improved that can result in a lesser non-stop cycle of the issue being transferred to multiple support channels. As such, these methods can result in prolonged resolution times, resource inefficiency, and frustration when handling complex and critical issues.

The efficiency of the resolution times of current solutions can be improved. Minor issues can also be solved more efficiently. The timeframe in which to solve more complex or critical problems can be improved as well. This time lag between the reporting of the issue and the solution can be improved to not disrupt a user's workflow, and also reduce frustration of the user during the user's workflow. The current methods can be improved so that the user can resume work without significant delays.

Users should be able to quickly identify or fix issues as they arise on their own, such as the issues that can impact productivity. The issues that can compromise the customer experience can be reduced. In addition, more than half of these issues could be easily resolved by providing users with suggested solutions without the need for manual intervention or complex support processes. More immediate access to solutions can be improved upon with present solutions.

Accordingly, a need exists for users to receive solutions to their user requests more efficiently. Users should be provided with more direct and concise solutions. In addition, present solutions can be improved upon to enable users to resume their workflow sooner. As such, system should be implemented to provide more direct solutions that are provided to users more efficiently to increase operational efficiency of the users'workflow and the operational efficiency of the computing system. An AI driven system is needed that provides users with intelligent and real-time solutions based on historical data and improves troubleshooting efficiency and also reduces dependency on manual support channels.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 depicts a block diagram of a computing system according to some exemplary implementations;

FIG. 2 is a flow diagram illustrating a system that provides solutions to user according to some example implementations;

FIG. 3 illustrates another flow diagram of a system the provides solutions to a specific user request according to some example implementations;

FIG. 4A depicts a graphical user interface that shows the resolution effectiveness of solutions provided to the graphical user interface according to some example implementations;

FIG. 4B depicts another illustration of the graphical user interface that shows the resolution effectiveness of solutions provided to the graphical user interface according to some example implementations;

FIG. 5 is a flow diagram illustrating a process according to some example implementations;

FIG. 6A is a block diagram illustrating an electronic device according to some example implementations; and

FIG. 6B is a block diagram of a deployment environment according to some example implementations.

### DETAILED DESCRIPTION

The following description describes implementations for providing solutions to directly and efficiently resolve user requests that occur at the front end, or graphical user interface (GUI) of a computing system. The Smartorg Autofix insight engine is an advanced, AI-powered troubleshooting tool designed to enhance computing environments. It integrates ML models that analyze user-reported problems and leverages semantic analysis and dynamic keyword mapping. By utilizing both supervised and unsupervised learning techniques, the system can continuously improve its ability to resolve issues and provide context-aware and automated solutions for complex user-related problems in real-time. The following solution described below can be applied onto a revenue cloud in various embodiments. Nevertheless, the following solution is not limited to the revenue cloud. The following solution can be applied to a variety of products and solutions. A user can log into a computing system and attempt to locate products in a product catalog, or quote prices for a listing of products. When the user is unable to obtain the full listing of products or quote prices for the listing of products, the user can submit a user request that describes the issues the user is having. The user can submit the user request through the GUI.

On the back end of the computing system, in response to the user request, a topic orchestrator, which can be a software module on the back end, can assign a topic to the user request. The assigned topic can relate to a product catalog or configurable settings to quote prices for the listing of products. The processor can process the user request with the assigned topic. A knowledge base updater on the back end can be coupled to the processor. The knowledge base updater can be a backend processor that determines the solutions that are needed to address the user request. The knowledge base updater can then generate the solutions. The generated solutions can include at least one preferred solution, and a plurality of other viable solutions. The knowledge base updater can transmit the solutions to a knowledge base. The knowledge base can be coupled to the knowledge base updater and the processor, and function as a memory for data storage. In addition to the solutions which the knowledge base updater generates in response to the user request, the knowledge base updater can continuously provide new and updated solutions to the knowledge base in scheduled intervals or periodic intervals. The knowledge base updater can continuously evolve and improve and provide new and updated solutions to the knowledge base. As such, the computing system can continuously improve and provide new and updated solutions.

The solutions to address the user request that are transmitted to the knowledge base can be incorporated with a large language model (LLM) and with artificial intelligence/machine learning (AI/ML) algorithms. The AI/ML incorporated solutions can then be transmitted back to the processor. The processor can then transmit the solutions back to the front end. At the GUI, the user can see the plurality of solutions and attempt each of the solutions in any order until the user request has been resolved. The user can inform the computing system when the user request still has not been resolved, and when the user request has been resolved. The processor on the back end can provide operational insights on the GUI. With the operational insights, the processor can determine if any of the solutions have resolved the user request. Any of the solutions may fully resolve, partially resolve, or not resolve the user request at all.

After receiving the solutions on the GUI, the user may attempt the viable solutions and receive either a partial resolution or no resolution at all. In such an instance, the user may not see a full listing of the products or be able to configure settings to quote prices for products. The user can then inform the computing system through the GUI that the user request still has not been resolved. The user can then attempt the preferred solution. The preferred solution can provide a full listing of the products, or allow the user to configure settings to update attributes on the products to quote prices for the products. When the user is able to view the desired request on the GUI, the user can determine that the user request has been resolved, and inform the computing system through the GUI that the issue has been resolved in real-time.

The processor can also assign a resolution effective score for each of the attempted solutions. The processor can determine that the solutions that did not fully resolve the user request would have a resolution effective score of less than one hundred percent. For the solution that fully resolved the user request, the processor can assign that solution a resolution effective score of one hundred percent. The top resolution effective score can be displayed on the GUI above the other resolution effective scores. A user can have the user request resolved in a matter of minutes with a more efficient and accurate solution.

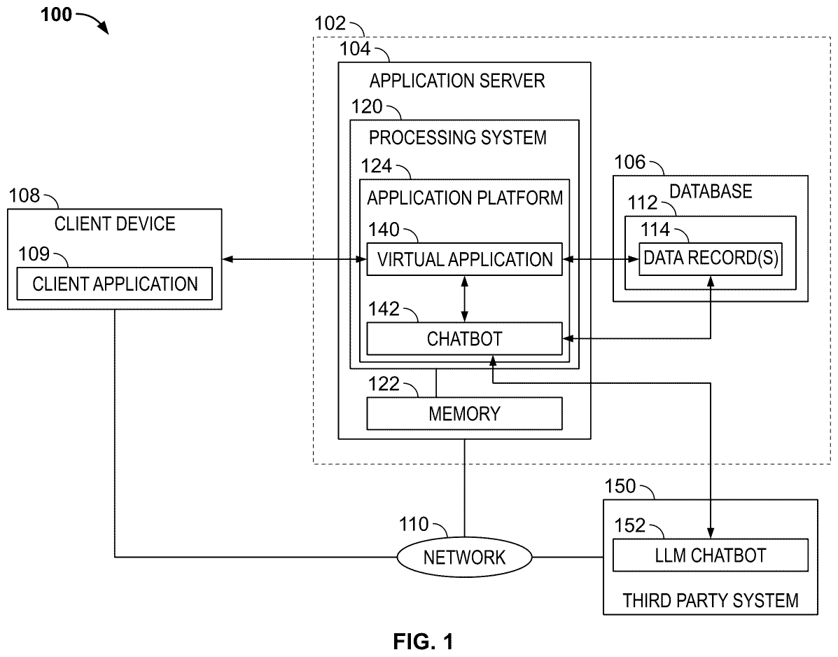

FIG. 1 depicts an exemplary depicts an exemplary computing system 100 including a database system 102 configurable to provide an application platform 124 capable of supporting conversational interactions with a user of a client device 108. A user can log into the computing system 100 and input the user request that includes the issues that the user would like to have resolved. The user request can relate to the user not be able to see a full listing of products in a product catalog, or not be able to see a full listing of prices for the products. The computing system 100 can display the user request which will be eventually sent to a backend of the computing system 100 for solutions. In exemplary implementations, the database system 102 can be capable of provisioning instances of one or more virtual applications 140 to client applications 109 at client devices 108 over a communications network 110 (e.g., the Internet or any sort or combination of wired and/or wireless computer network, a cellular network, a mobile broadband network, a radio network, or the like), where the virtual applications 140 invoke, include or otherwise incorporate a conversational interaction service 142 that is configurable to support conversational interactions and interface with an LLM-based chatbot service 152, as described in greater detail below. For purposes of explanation, the conversational interaction service 142 may alternatively be referred to herein as a chatbot service in the context of an exemplary implementation providing substantially real-time conversational interactions with an end user the context of a chat window associated with an instance of the virtual application 140. However, it should be appreciated that the subject matter described herein is not limited to chatbots and the conversational interaction service 142 may be configurable to support any number of different types or forms of conversational interactions in an automated manner (e.g., by automatically generating responsive emails, text messages, and/or the like). Accordingly, it should be appreciated that FIG. 1 is a simplified representation of a computing system 100 and is not intended to be limiting.

In one or more exemplary implementations, the database system 102 includes one or more application servers 104 that support an application platform 124 capable of providing instances of virtual web applications 140, over the network 110, to any number of client devices 108 that users may interact with to view, access or obtain data or other information from one or more data records 114 maintained in one or more data tables 112 at a database 106 or other repository associated with the database system 102. For example, a database 106 may maintain, on behalf of a user, tenant, organization or other resource owner, data records 114 entered or created by that resource owner (or users associated therewith), files, objects or other records uploaded by the resource owner (or users associated therewith), and/or files, objects or other records automatically generated by one or more computing processes (e.g., by the server 104 based on user input or other records or files stored in the database 106). In this regard, in one or more implementations, the database system 102 is realized as an on-demand multi-tenant database system that is capable of dynamically creating and supporting virtual web applications 140 based upon data from a common database 106 that is shared between multiple tenants, which may alternatively be referred to herein as a multi-tenant database. Data and services generated by the virtual web applications 140 may be provided via the network 110 to any number of client devices 108, as desired, where instances of the virtual web application 140 may be suitably generated at run-time (or on-demand) using a common application platform 124 that securely provides access to the data in the database 106 for each of the various tenants subscribing to the multi-tenant system.

The application server 104 generally represents the one or more server computing devices, server computing systems or other combination of processing logic, circuitry, hardware, and/or other components configured to support remote access to data records 114 maintained in the data tables 112 at the database 106 via the network 110. Although not illustrated in FIG. 1, in practice, the database system 102 may include any number of application servers 104 in concert with a load balancer that manages the distribution of network traffic across different servers 104 of the database system 102.

In exemplary implementations, the application server 104 generally includes at least one processing system 120, which may be implemented using any suitable processing system and/or device, such as, for example, one or more processors, central processing units (CPUs), controllers, microprocessors, microcontrollers, processing cores, application-specific integrated circuits (ASICs) and/or other hardware computing resources configured to support the operation of the processing system described herein. Additionally, although not illustrated in FIG. 1, in practice, the application server 104 may also include one or more communications interfaces, which include any number of transmitters, receivers, transceivers, wired network interface controllers (e.g., an Ethernet adapter), wireless adapters or another suitable network interface that supports communications to/from the network 110 coupled thereto. The application server 104 also includes or otherwise accesses a data storage element 122 (or memory), and depending on the implementation, the memory 122 may be realized as a random access memory (RAM), read only memory (ROM), flash memory, magnetic or optical mass storage, or any other suitable non-transitory short or long term data storage or other computer-readable media, and/or any suitable combination thereof. In exemplary implementations, the memory 122 stores code or other computer-executable programming instructions that, when executed by the processing system 120, are configurable to cause the processing system 120 to support or otherwise facilitate the application platform 124 and related software services that are configurable to subject matter described herein.

The client device 108 generally represents an electronic device coupled to the network 110 that may be utilized by a user to access an instance of the virtual web application 140 using an application 109 executing on or at the client device 108. In practice, the client device 108 can be realized as any sort of personal computer, mobile telephone, tablet or other network-enabled electronic device coupled to the network 110 that executes or otherwise supports a web browser or other client application 109 that allows a user to access one or more GUI displays provided by the virtual web application 140. In exemplary implementations, the client device 108 includes a display device, such as a monitor, screen, or another conventional electronic display, capable of graphically presenting data and/or information along with a user input device, such as a touchscreen, a touch panel, a mouse, a joystick, a directional pad, a motion sensor, or the like, capable of receiving input from the user of the client device 108. Some implementations may support text-to-speech, speech-to-text, or other speech recognition systems. In such instances, the client device 108 may include a microphone or other audio input device that functions as the user input device, with a speaker or other audio output device capable of functioning as an output device. The illustrated client device 108 executes or otherwise supports a client application 109 that communicates with the application platform 124 provided by the processing system 120 at the application server 104 to access an instance of the virtual web application 140 using a networking protocol. In some implementations, the client application 109 is realized as a web browser or similar local client application executed by the client device 108 that contacts the application platform 124 at the application server 104 using a networking protocol, such as the hypertext transport protocol secure (HTTPS). In this manner, in one or more implementations, the client application 109 may be utilized to access or otherwise initiate an instance of a virtual web application 140 hosted by the database system 102. The virtual web application 140 provides one or more web page GUI displays within the client application 109 that include GUI elements for interfacing and/or interacting with records 114 maintained at the database 106.

In exemplary embodiments, the database 106 stores or otherwise maintains data for integration with or invocation by a virtual web application 140 in objects organized in object tables 112. In this regard, the database 106 may include any number of different object tables 112 configured to store or otherwise maintain alphanumeric values or other descriptive information that define a particular instance of a respective type of object associated with a respective object table 112. For example, the virtual application may support a number of different types of objects that may be incorporated into or otherwise depicted or manipulated by the virtual application. Each different type of object can be having a corresponding object table 112 that includes columns or fields corresponding to the different parameters or criteria that define a particular instance of that object. In some implementations, the database 106 stores or otherwise maintains application objects (e.g., an application object type) where the application object table 112 includes columns or fields corresponding to the different parameters or criteria that define a particular virtual web application 140 capable of being generated or otherwise provided by the application platform 124 on a client device 108. In this regard, the database 106 may also store or maintain GUI objects that may be associated with or referenced by a particular application object and include columns or fields that define the layout, sequencing, and other characteristics of GUI displays to be presented by the application platform 124 on a client device 108 in conjunction with that application 140.

In exemplary implementations, the database 106 stores or otherwise maintains additional database objects for association and/or integration with a virtual web application 140, which may include custom objects and/or standard objects. For example, an administrator user associated with a particular resource owner may utilize an instance of a virtual web application 140 to create or otherwise define a new custom field to be added to or associated with a standard object, or define a new custom object type that includes one or more new custom fields associated therewith. In this regard, the database 106 may also store or otherwise maintain metadata that defines or describes the fields, process flows, workflows, formulas, business logic, structure and other database components or constructs that may be associated with a particular application database object. In various implementations, the database 106 may also store or otherwise maintain validation rules providing validation criteria for one or more fields (or columns) of a particular database object type, such as, minimum and/or maximum values for a particular field, a range of allowable values for the particular field, a set of allowable values for a particular field, or the like. The database 106 may also store or maintain workflow rules or logical criteria associated with respective types of database object types that define actions, triggers, or other logical criteria or operations that may be performed or otherwise applied to entries in the various database object tables 112 (e.g., in response to creation, changes, or updates to a record in an object table 112).

Still referring to FIG. 1, in exemplary implementations, the code or other programming instructions associated with the application platform 124 and/or the virtual web applications 140 may be configurable to incorporate, invoke or otherwise include a chatbot service 142. The chatbot service 142 generally represents a software component capable of providing or otherwise supporting an automated agent or chatbot service capable of exchanging chat messages or providing other conversational responses. The messages or responses may include text-based messages that include plain-text words only, and/or rich content messages that include graphical elements, enhanced formatting, interactive functionality, or the like. Depending on the implementation, the chatbot service 142 can be integrated with or otherwise incorporated as part of the virtual application 140, or be realized as a separate or standalone process, application programming interface (API), software agent, or the like that is capable of interacting with the client device 108 independent of the virtual application 140. In practice, the chatbot service 142 may incorporate or otherwise reference a vocabulary of words, phrases, phonemes, or the like associated with a particular language that supports conversational interaction with the user of the client device 108. For example, the vocabulary may be stored or otherwise maintained at the database system 102 (e.g., in the database 106 or memory 122) and utilized by the chatbot service 142 to provide speech recognition or otherwise parse and resolve text or other conversational input received via a GUI or chat window associated with the chatbot service 142. The vocabulary may also be used to generate or otherwise provide conversational output (e.g., text, audio, or the like) to the client device 108 for presentation to the user (e.g., in response to received conversational input).

In exemplary implementations, the chatbot service 142 receives or otherwise obtains a conversational input from a user of the client device 108 (e.g., via client application 107 and network 110). The chatbot service 142 also parses the conversational input using the conversational vocabulary associated with the chatbot service 142 to identify or otherwise discern an intent of the user or another action that the user would like to perform and automatically respond in a corresponding manner. The chatbot service 142 can be updating the chat window or other GUI display associated with the conversation with the chatbot service 142 to include a graphical representation of a conversational response generated by the chatbot service 142 responsive to the conversational user input prompt received from the user. In this manner, a user of a client device 108 interacts or otherwise communicates with the chatbot service 142 via an associated GUI display within the client application 109 (e.g., a chat window) to transmit or otherwise provide conversational user input in the context of a conversation with the chatbot service 142. Depending on the implementation, the conversational input may be received by the user selecting or otherwise activating a GUI element presented within the chat window, or the user may input (e.g., via typing, swiping, touch, voice, or any other suitable method) a conversational string of words in a free-form or unconstrained manner, which is captured by a user input device of the client device 108 and provided over the network 110 to the application platform 124 and/or the chatbot service 142 via the client application 109. The chatbot service 142 then parses or otherwise analyzes the conversational input using natural language processing (NLP) to identify the intent or other action desired by the user based on the content, syntax, structure and/or other linguistic characteristics of the conversational input.

In one or more implementations, when the chatbot service 142 determines it is unable to ascertain the intent of a received conversational user input or is otherwise unable to respond to the received conversational user input based on the vocabulary and/or other data that is accessible to or otherwise associated with the chatbot service 142, the chatbot service 142 analyzes the received conversational user input. The chatbot service 142 analyzes the conversational user input to determine whether or not to forward the received conversational user input as an input prompt to a LLM-based chatbot service 152 for generating a corresponding LLM-based automated conversational response to the received conversational user input. In this regard, the LLM-based chatbot service 152 may be realized as an application programming interface (API), software agent, or the like that is capable of receiving a textual input prompt and providing a corresponding natural language textual response to the received input prompt using a LLM and corresponding artificial intelligence or machine learning techniques such that the natural language textual response represents a logical and coherent response to the textual input prompt.

In one or more exemplary implementations, the LLM-based chatbot service 152 is hosted or otherwise implemented at an external computing system 150 on the network 110. The external computing system 150 generally includes at least one server communicatively coupled to the network 110 to support access to the LLM-based chatbot service 152. In this regard, in some implementations, the external computing system 150 is physically and logically distinct from the database system 102 and/or the application platform 124. For example, the external computing system 150 may be owned, controlled, or otherwise operated by a third party different from the parties that own, control and/or operate the database system 102 and/or the application platform 124. That said, in other implementations, the external computing system 150 may be affiliated with the same party that owns, controls and/or operates the database system 102 and/or the application platform 124.

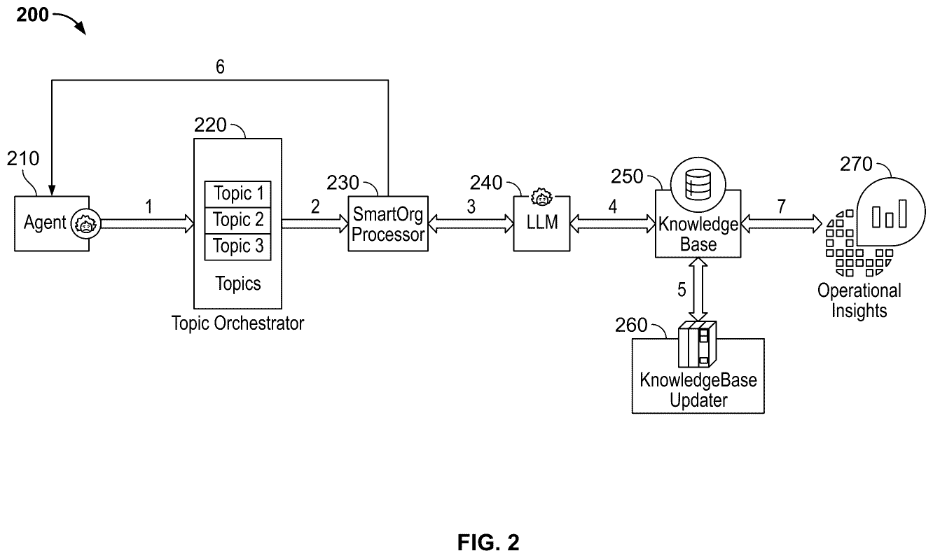

Referring to FIG. 2, and with continued reference to FIG. 1, a flow diagram 200 is illustrated that further describes the backend processing that occurs to provide solutions in response to a user request that is received and displayed on a GUI of the computing system described in FIG. 1. At 210, a user submits a user request at the GUI on the computing system. The user request can indicate an issue that needs to be resolved. Such issues can include, but are not limited to, not seeing price listings for products, or not seeing available products in a product catalog. In other embodiments, the user can indicate other issues as well, such as not being able to configure or update settings to quote prices for a product. After the user request is submitted to the GUI, at 220, a topic orchestrator on the backend of the computing system can then assign a topic to the user request. The topic orchestrator can be a software module on the backend that assigns topics to any user requests that are received. The topic orchestrator can assign a topic to the user request. The assigned topics can include, but are not limited to, a listing of products in a product catalog, pricing of products in a product catalog, or configurable settings to quote prices for products. After the topic orchestrator has assigned the user request a topic, a smart organizational processor or processor at 230 can then process the user request with the assigned topic.

In FIG. 2, a backend knowledge base updater at 260 can then receive the user request with the assigned topic, and determine a plurality of solutions to address the user request with the assigned topic. The knowledge base updater can be a backend processor that can generate three or more solutions to address the user request with the assigned topic in multiple time intervals. The knowledge base updater can have solutions which get updated on a periodic basis. The topic can get passed to the LLM which references a knowledge base as one of the sources of data. One of the solutions can be a preferred solution that can be mostly likely to resolve the issue with the user request. The other solutions, though viable, may not be as likely as the preferred solution to resolve the user request. The knowledge base updater can provide the solutions to a knowledge base at 250 that is coupled to the knowledge base updater. The knowledge base can function as a memory or data storage within the computing system and can be coupled to the processor and the knowledge base updater. The knowledge base updater can also generate new and updated solutions to be stored in the knowledge base after providing the solutions to transmit to the processor in response to the user request. The knowledge base updater can provide the additional solutions to the knowledge base that are updated from the plurality of solutions transmitted back to the GUI. The knowledge base updater can continuously evolve and improve and provide the new and updated solutions to the knowledge base in scheduled or periodic intervals after generating the solutions to address the user request. The knowledge base updater is AI-driven and evolves based on data from previous user interactions. For instance, the knowledge base updater leverages machine learning algorithms to continuously analyze feedback from users and automatically enhance the solution database. Over time, this results in an increasingly accurate knowledge base with fewer support escalations. Over time, the knowledge base updater can continuously provide new and updated solutions to provide for other user requests that can be received within the computing system.

Referring again to FIG. 2, when the knowledge base updater generates the solutions to address the user request, which it then sends to the knowledge base at 250, the solutions can incorporate LLM and AI/ML algorithms at 240. Al/ML algorithms can be applied to the user request with the assigned topic before the plurality of solutions are provided to the GUI. After the solutions have incorporated the LLM and AI, the solutions can be provided to the processor at 230. The processor can then transmit the solutions back to the GUI at 210 for the user to view and apply. Nevertheless, AI/ML models are not only used to enhance solution accuracy but are designed to learn in real time from the user's interactions. For example, the AI/ML models continuously refine their output by learning from user interactions, ensuring that the system becomes more accurate with each resolution attempt, thus minimizing the need for human intervention. As such, the AI/ML can learn from the user interactions with the solutions on the GUI.

In FIG. 2, at 210, the user can apply the solutions provided by the knowledge base updater in any order to determine if any of the solutions can resolve the issue associated with the user request and assigned topic. The user can then apply the solutions on the GUI. The user may attempt the other two viable solutions first. The two viable solutions may partially resolve or not resolve the user request at all. With partial or no resolution, the user may not see a full listing of products or prices of products in a product catalog. With the partial resolution or no resolution outcome, the user can alert the computing system through the GUI that the user request has still not been resolved. The user can then attempt the preferred solution. In embodiments, the preferred solution can resolve the user request. With the full resolution, the user can see a full listing of products or the full listing of prices of the products in the product catalog. The user can alert the computing system through the GUI that the user request has been resolved. The processor can then determine a resolution effective score and provide operational insights for each of the solutions at 270. The resolution effectiveness score (RES) can be computed dynamically, considering factors such as time to resolution, user feedback, and accuracy of the solution. The system continuously adjusts the weightings for these factors based on historical performance, ensuring that higher scoring solutions are prioritized.

Referring again to FIG. 2, the processor can determine whether at least one of the plurality of solutions resolved the user request before transmitting a support ticket to the graphical user interface to escalate the user request to a call center or help desk center. The resolution effective score can show how each solution fared with the user request. The preferred solution that completely resolved the user request can have a high resolution score. The processor can assign the preferred solution a resolution effective score of one hundred percent that would be displayed on the GUI in real-time. The processor can determine the resolution effective scores for the at least two other solutions to be less than one hundred percent. The resolution effective score of the preferred solution can be displayed above the resolution effective score of the other solutions.

In FIG. 2, in an embodiment, the preferred solution and the at least two other solutions may not resolve the user request. In such an instance, the processor can generate a support ticket for the user to use to call a help desk center to resolve the user request. However, in most instances, at least one of the solutions provided can resolve the user request. Further, at least one of the solutions can resolve the user request in substantially less time than the help desk center. The knowledge base updater is AI-driven and evolves based on data from previous user interactions. The knowledge base updater leverages ML algorithms to continuously analyze feedback from users and automatically enhance the solution database. Over time, this results in an increasingly accurate knowledge base with fewer support escalations. It can take days for the help desk center to resolve the issue. In contrast, the method 200 described above can resolve the issue in a couple of hours or in a matter of minutes. As such, the method 200 can computationally improve the efficiency in which users receive solutions to typical user requests in a computing system. The scalability of the system can improve as well. The users can resume their workflow in less time than from a traditional call center or help desk center.

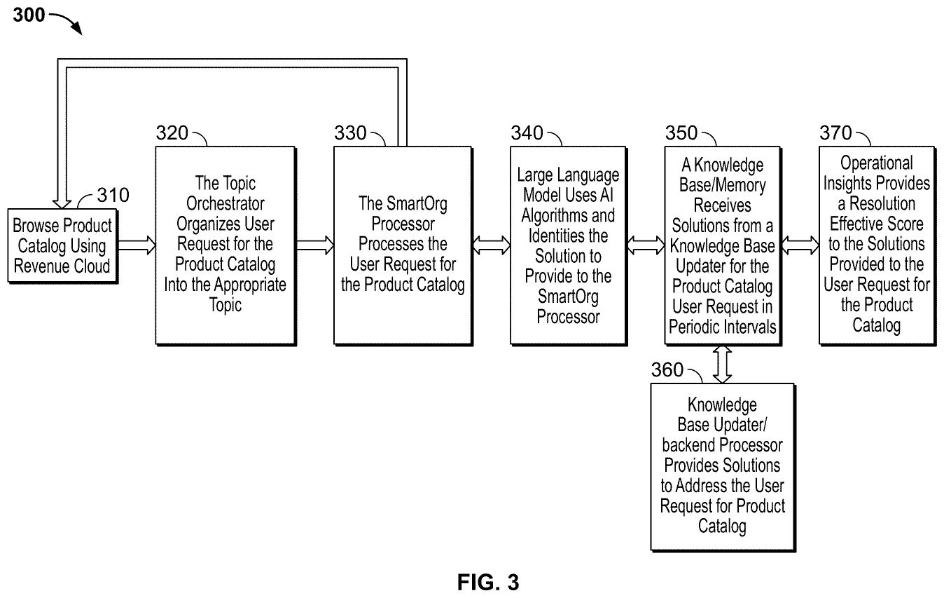

Referring to FIG. 3, with continued reference to FIGS. 1-2, another flow diagram 300 is illustrated with a specific illustration of a user request described in FIG. 2. At 310, a user can log into the computing system with a user request. The user request can relate to a specific example of the availability of products in a product catalog. A product catalog may not be showing a complete listing of the products that the user wants to view on a GUI. Accordingly, the user can be having an issue with the availability of the complete listing of the products being shown on the GUI. The user can submit a user request that details the issue that the user is having with viewing the complete listing of products in a product catalog. Then at 320, the topic orchestrator can assign a topic to the user request. The topic can relate to product listings for the product catalog. At 330, the smart organizational processor or processor in the computing system can process the user request with the assigned topic.

In FIG. 3, at 360, the knowledge base updater can determine a plurality of solutions to provide to address the user request in which the full listing of products in the product catalog is not being shown. As in FIG. 2, the knowledge base updater at 360 can be a backend processor that generates solutions in response to the user request. Further, the knowledge base updater can continuously evolve and improve by generating new solutions that are updated from previous solutions which the knowledge base updater has generated in prior intervals. The knowledge base updater can send the generated solutions to the knowledge base at 350. The knowledge base updater can also continuously send new and improved solutions to the knowledge base at scheduled or periodic intervals. The knowledge base can be a memory coupled to the processor and the knowledge base updater. The knowledge base can store solutions that it receives from the knowledge base updater as well as instructions from the processor. As mentioned above, the knowledge base updater can continuously evolve with new and improved solutions to provide to the knowledge base in future time intervals. As such, the knowledge base updater at 360 can continuously improve in its capabilities with providing newer and updated solutions.

Referring again to FIG. 3, in response to the processed user request and assigned topic, the knowledge base updater can generate a preferred optimal solution, and at least one other solution to address the user request. The knowledge base updater, after generating the preferred solution and the at least one other solution, can provide the solutions to the knowledge base at 350. The solutions can be incorporated with AI/ML algorithms with the LLM at 340. The processor at 330 can then receive the AI incorporated solutions to provide to the GUI. The processor at 330 can then transmit the plurality of solutions to the GUI at 310 for the user to view and apply. When the user sees the proposed solutions on the GUI, the user can apply each of the plurality of solutions, including the preferred solution in any order. The user can apply the at least one other solution and receive a partial resolution or no resolution to the user request. With the partial resolution or no resolution, either a partial listings of the products in the product catalog will be shown, or no product listings will be shown. The user can inform the computing system through the GUI that the user request has not been fully resolved. The user can then attempt the preferred solution, which can then fully resolve the user request. With the full resolution, a full listing of the products in the product catalog can be shown. The user can inform the computing system then that the user request has been resolved. At 370, the processor can determine the operational insights of each of the solutions. With the operational insights, the processor can determine the RES for each of the solutions, including the preferred solution. As such, the processor can determine if any of the solutions resolved the issues. The processor can determine if a help support ticket is needed for the user based on the RES for each of the solutions.

Referring again to FIG. 3, in most instances, a help support ticket may not be required for the user. The processor can determine that the at least two other solutions partially resolved or did not resolve the user request, and assign them resolution effective scores of less than one hundred present. With a partial resolution, the at least two other solutions can show more of the available products in the product catalog, but not a full listing of the products in the product catalog. With no resolution, the at least one other solution may not have shown any of the product listings in the product catalog. As such, the processor can assign an RES of less than one hundred percent. In addition, the processor can determine that the preferred solution fully resolved the user request by showing a full listing of the products on the GUI that the user was previously unable to see. Accordingly, the processor can assign an RES of one hundred percent for the preferred solution. The solution with the highest RES can be displayed above the other solutions on the GUI.

The method described in the flow diagram 300 can significantly reduce the number of user requests that have to be escalated to a help desk center. Moreover, escalation can only be done when all AI-driven solutions fail, and human intervention is needed. In cases where the AI-powered solutions do not fully resolve the user request, the system automatically generates a support ticket and escalates the issue to the appropriate team, ensuring that high-priority issues are addressed without manual intervention. The knowledge base updater can provide at least one preferred solution for each of the plurality of solutions that are provided in response to a user request. Further, the knowledge base updater can be continuously improving with new solutions that are updated from previous solutions that are provided. As such, the knowledge base updater can continuously provide new and updated solutions that can be improved upon prior solutions that can increase the likelihood of resolving most user requests. As a result, the computing system can be improved since it can provide more accurate and timely resolutions to user requests in minutes as opposed to help desk centers. The user or users can also resume their workflow more efficiently as well.

As in FIG. 2, in FIG. 3, in an embodiment, the processor can also determine that none of the provided solutions have resolved the user request. In such an instance, the processor can provide a support ticket for the user at the graphical user interface. With the support ticket, the user can contact a help center for support. Nevertheless, in most instances at least one of the solutions provided can resolve the user request. Moreover, in most embodiments and instances, the generated solutions from the knowledge base updater can reduce the need for the user to contact a help center by seventy to eighty percent or more. As mentioned, the knowledge base updater can continuously provide new and updated solutions from prior solutions to ensure that more user requests can be resolved without the need for a help desk center. The knowledge base updater and the overall process can provide a more efficient and effective solution in comparison to the help desk center. Therefore, the user is given more efficient solutions in substantially less time, and thereby may require much less help from the traditional help desk center or call center as a result.

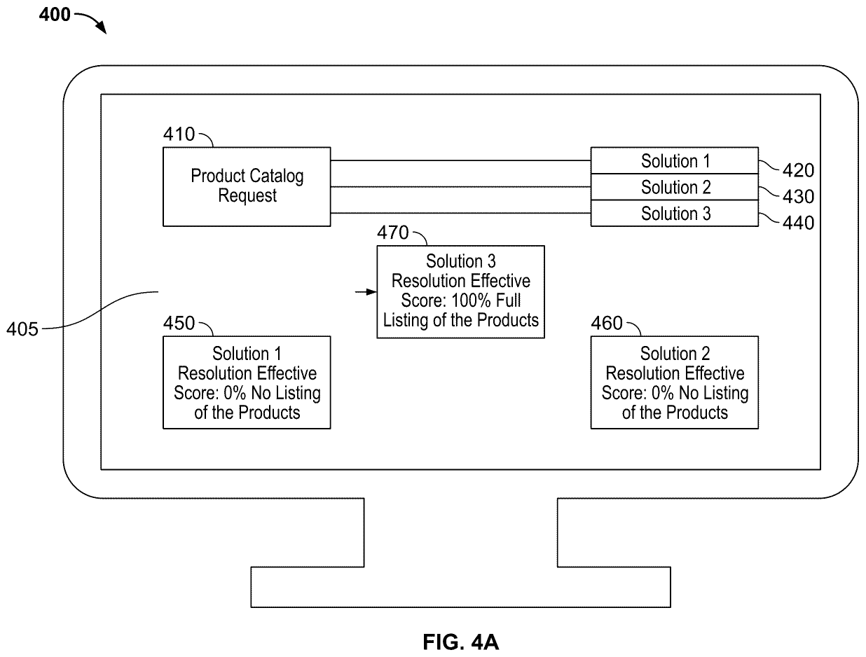

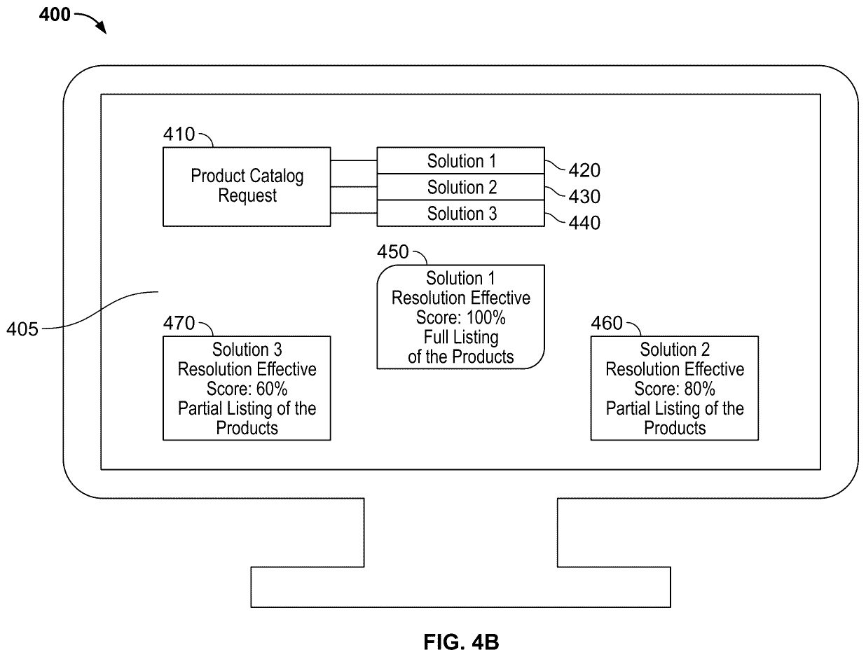

In FIG. 4A, with continued reference to FIGS. 1-3, a computing system 400 is illustrated that shows results of the operational insights that are described in FIGS. 2-3. The computing system 400 illustrates a GUI 405. Within the GUI 405, a product catalog request 410 that refers to the user request described in FIG. 3 is illustrated. The user can submit a user request in which a full listing of the products for the product catalog request 410 is not being displayed. In response to the user request, the knowledge base updater described in FIGS. 2-3 can provide a plurality of solutions 420, 430, 440. At least one of the solutions 420, 430, 440, such as the solution 440, can be a preferred solution. The user can attempt the solutions 420, 430, 440 in any order. Based on how the solutions 420, 430, 440 resolve the product catalog request 410, the processor can determine the resolution effective score for each of the solutions. The resolution effectiveness of the plurality of solutions 420, 430, 440 can enable the processor to determine whether additional support channels are required to address the product catalog request 410. Two of the solutions, such as the solution 420 and the solution 430 may not resolve the product catalog request 410 at all. When the user attempts the solution 420 and the solution 430, the user may not see any listing of the products in the product catalog. The user may inform the computing system 400 through the GUI 405 that the product catalog request 410 has still not been resolved.

Referring again to FIG. 4A, the user can still attempt to resolve the product catalog request 410. As a result, the user can then attempt the solution 440. After attempting the solution 440, the product catalog request 410 can be resolved, and a full listing of the products in the product catalog can be shown. The user can also alert the computing system 400 that the product catalog request 410 has been resolved. In response to the application of the solutions 420, 430, and 440, the processor can provide operational insights and assign each of the solutions 420, 430, 440 a resolution effective score. As such, the processor can assign a resolution effective score 450 of zero percent for the solution 420, and a resolution effective score 460 of zero percent for the solution 430 because the solutions 420, 430 did not show any listings of the products in the product catalog. For the solution 440, the processor can assign a resolution effective score 470 of one hundred percent because the solution 440 fully resolved the product catalog request 410 and showed a full listing of the products on the GUI 405. The highest resolution effective score 470 can be displayed above the resolution effective scores 450, 460 on the GUI 405 in real-time.

In FIG. 4B, with continued reference to FIGS. 1-4A, in an embodiment, the solutions 430, 440 may be able to provide some of the product listings in response to the product catalog request 410, but not all of the listings. After the user has received each of the solutions 420, 430, 440 on the GUI 405, the user may attempt the solutions 420, 430, 440 in any particular order. The user can thereby attempt the solutions 430, 440. After attempting the solution 430, the user may see only a partial listing of the products in the product catalog. As a result, the user may inform the computing system 400 that the product catalog request 410 is not still fully resolved. The user may then attempt the solution 440 on the product catalog request 410. The solution 440 may provide a lesser number of the product listings in the product catalog in comparison to the solution 430, and may still only partially resolve the product catalog request 410. In response, the user may alert the computing system 400 that the product catalog request 410 has still not been fully resolved. The user can then attempt the solution 420 onto the product catalog request 410. The solution 420 may fully resolve the product catalog request 410 and display the full listings of the products in the product catalog. The user can then inform the computing system that the product catalog request 410 has been fully resolved.

In FIG. 4B, the processor can provide the operational insights and assign resolution effective scores to the solutions 420, 430, and 440. With the partial resolutions of the solutions 430, and 440, the processor can assign resolution effective scores 460, 470 of eighty percent and sixty percent respectively. For the solution 420 that fully resolved the product catalog request 410, the processor can assign a resolution effective score 450 of one hundred percent. The resolution effective score 450 can displayed above the other resolution effective scores 460, 470 on the GUI 405 in real-time. As such, the user can have the product catalog request 410 fully resolved in a matter of minutes due to the knowledge base updater providing solutions within the computing system 400. The scalability and efficiency of the computing system 400 can be improved as well.

In FIGS. 4A-4B, in another embodiment, the user request can include, instead of the product catalog request 410, the price listing for products in a product catalog. The user can submit a request that the user cannot view the price listings for products in a product catalog on the GUI 405. The knowledge base updater can provide the solutions 420, 430, 440 that can be provided to the GUI 405 in real-time in response to the user request for the price listings of products. The user can attempt each of the solutions 420, 430, 440 to determine if any of the solutions resolve the user request. At least one of the solutions 420, 430, 440 can fully resolve the user request, while two of the solutions 420, 430, 440 may not resolve the user request at all, or may partially resolve the user request. The user can inform the computing system 400 when the user request has not been fully resolved, and when the user request has been fully resolved. The processer can determine the resolution effective scores 450, 460, 470 for each of the solutions 420, 430, 440. At least one solution among the solutions 420, 430, 440 which fully resolved the user request can be assigned a resolution effective score of one hundred percent and be listed above the other resolution effective scores on the GUI 405. For the other two solutions among the solutions 420, 430, 440 which did not resolve the user request completely, the processor can assign resolution effective scores of less than one hundred percent. The operational insights with respect to the resolution effective scores for each of the solutions can be displayed on the GUI 405 in real-time. The highest resolution effective score among the resolution effective scores 450, 460, 470 can be listed above the other resolution effective scores.

Referring again to FIGS. 4A-4B, in yet another embodiment, the user can submit a user request on the GUI with respect to not being able to update attributes on products. Such attributes can include updating the listing on the type of product, or being able to quote prices for each product. Due to these issues, the user can submit the request through the GUI 405. In response, after the topic orchestrator assigns a topic, and the processor processes the user request, the knowledge base updater on the back end can provide a plurality of solutions 420, 430, 440 which can be incorporated with AI and transmitted back to the user to view at the GUI 405. The processor can transmit the solutions to the GUI 405 for the user to apply to the user request. The user can try each of the solutions 420, 430, 440 provided to determine if the user can fully update all the attributes on the products that the user may want to update. As such, as in the product catalog user request 410 described above, the user can try each of the provided solutions 420, 430, 440 in any order.

Still referring to FIGS. 4A-4B, several of the received solutions among the solutions 420, 430, 440 may partially resolve the issue or not resolve the issue at all. The processor can determine that several of the solutions among the solutions 420, 430, 440 have not resolved the user request. The user can also alert the computing system 400 that the user request has not been fully resolved. The processor can assign a resolution effective scores of less than one hundred percent to several of the solutions among the solutions 420, 430, 440. Nevertheless, one of the solutions among the solutions 420, 430, 440 can fully resolve the user request. When the user request is fully resolved, the user can thereby update all the attributes on the products that the user may want to update after applying the preferred solution. The attributes can include being able to quote prices for the products and update descriptions of the products as well. The user can then alert the system through the GUI 405 that the user request has been resolved. The processor can also assign a resolution effective score of one hundred percent to the solution among the solutions 420, 430, 440 which fully resolved the user request. The GUI 405 can display the highest resolution effective score above the other resolution effective scores among the resolution effective scores 450, 460, 470.

With respect to FIGS. 4A-4B, the user can have the user request resolved in real-time efficiently. The user can attempt each of the solutions 420, 430, 440 in any order in response to receiving the solutions after submitting the user request. The user can communicate through the GUI 405 whether any of the solutions have fully resolved the issue with the user request. The processor can also determine the resolution effective scores 450, 460, 470 in real-time. As such, the user can quickly have the issue for the user request resolved in a matter of minutes in most embodiments without the need to have the user request escalated to a help desk center or call center. In addition, the computing system 400 can continuously receive updated and improved solutions in upcoming intervals to address new user requests. The knowledge base updater can continuously improve and evolve in upcoming intervals and continuously provide new and updated solutions in scheduled or periodic intervals. As a result, the efficiency in which user requests are resolved can continue to improve in real-time. In addition, the number of user requests which may need to be escalated to a help desk center or call center can decrease as well. The efficiency and scalability of the computing system 400 can be improved as accurate solutions can be found more efficiently that can enable the user or users to resume their workflow more efficiently as well.

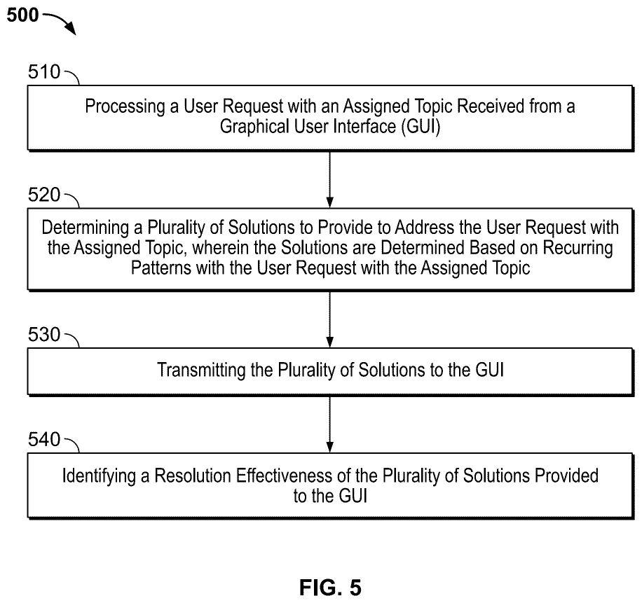

With continued reference to FIGS. 1-4B, in FIG. 5, a flow diagram 500 is illustrated in which a user request can be resolved by a system in real-time. A user can indicate one or more issues with the request. The system can receive the request, and in response provide a plurality of solutions for the user to employ in the real-time. The user can receive the solutions from the system in a few minutes. The user can ultimately receive at least one solution that fully resolves the user request. The user can communicate with the computing system when the request has been resolved. The processor within the system can also indicate resolution effective scores for each of the solutions which were applied onto the user request. Overall, the user can have the user request solved in real-time accurately and efficiently, and resume workflow more efficiently as a result.

In FIG. 5, at 510, a processor can process a user request that identifies an assigned topic which the user has submitted on the GUI. The processor, coupled to the GUI, can receive the user request with an assigned topic displayed on the GUI. The user request can relate to a product catalog in which the user cannot view all of the products in the product catalog. The user request could also be in relation to price listings of products, wherein the user is unable to see the complete listing of prices for products in a product catalog. A topic orchestrator on the back end of the computing system can assign a topic to the user request after the request is sent through the GUI. The processor can then process the user request with the assigned topic.

Referring again to FIG. 5, at 520, the knowledge base updater can generate a plurality of solutions to address the issues with the user request after the processor has processed the user request with the assigned topic. The knowledge base updater can be coupled to the processor. The knowledge base updater can also determine a plurality of solutions to address the user request with the assigned topic. In some embodiments, the knowledge base updater can identify and generate at least three solutions to provide to the processor to transmit to the GUI. The plurality of solutions can include a preferred solution among the plurality solutions. The knowledge base updater can also generate the plurality of solutions based on recurring patterns associated with the user request with the assigned topic.

The knowledge base updater can function as a backend processor that can generate solutions to address any incoming user requests within the computing system. The knowledge base updater can continuously improve and provide updated and improved solutions over solutions that the knowledge base updater previously provided. The continuous evolving and improvement of the knowledge base updater can increase the likelihood of resolving the current user request. When the knowledge base updater has generated the solutions to address the user request, the knowledge base updater can send the solutions to a knowledge base within the computing system. The knowledge base can function as a memory within the computing system. The knowledge base updater can provide updates and new solutions to the knowledge base in periodic intervals. The knowledge base can be coupled to the knowledge base updater and the processor. The solutions can be incorporated with LLM and AI/ML algorithms and be sent to the processor.

In FIG. 5, at 530, the processor can send the plurality of solutions received from the knowledge base updater to the GUI. The user can view the proposed solutions on the GUI. The user can also apply each of the solutions onto the user request in any order. The user can determine if any of the solutions fully resolve the user request. The solutions can either fully resolve, partially resolve, or not resolve the request at all. The user can apply each of the solutions until at least one of the solutions has resolved the user request. The user can also inform the system when the preferred solution or other viable solutions that were provided have resolved the user request.

Referring to FIG. 5, at 540, the processor can identify the resolution effectiveness of each of the plurality of solutions that are provided to the GUI. The processor can determine if at least one of the solutions provided to the graphical user interface provided a resolution for the user request. The processor can identify whether the user request with the assigned topic has to be escalated to other support channels for resolutions based on resolution effective scores of the plurality of solutions. As mentioned above, the user can apply each of the solutions in any order to resolve the user request. The user can attempt the viable solutions, and may receive a partial resolution or no resolution to the user request. For product listings or price listings, a partial resolution may only show some product listings or price listings, but not a complete listing of the products or prices. With no resolution, no product listings or price listings may be shown. The processor can determine a resolution effective score for each of the viable solutions to be less than one hundred percent.

Still referring to FIG. 5, the user can also try the preferred solution. In response to applying the preferred solution, the user request can be fully resolved in real-time. With the full resolution, the entire listing of products or the full price listings for the products can be shown. The user can alert the system that the user request has been resolved. The processor can also determine that the resolution effective score for the preferred solution to be one hundred percent. In response to the results of the solutions being applied to the user request, the processor can provide the operational insights onto the GUI. The processor can identify a resolution effective score for each of the solutions provided in real-time.

In FIGS. 1-5, a process is described in which users can have their user requests solved more efficiently by a computing system as opposed to having the user requests routed to a traditional call center or help center. A user can submit the user request onto a GUI of the computing system. In response to the user request, a topic orchestrator, can assign a topic to the user request. The topic can be assigned based on the type of user request, such as for product listings, or price listings. A processor can receive the user request with the assigned topic, and process the user request and assigned topic. A knowledge base updater coupled to a knowledge base and the processor can then generate a plurality of solutions in response to the user request.

The knowledge base updater can function as a backend processor that can generate a preferred solution and other viable solutions to address the user request. In addition, the knowledge base updater can continuously generate improved and updated solutions in scheduled intervals in addition to the solutions that the knowledge base updater provides in response to the user request. As such, the knowledge base updater can determine and generate new solutions to provide to the processor in upcoming intervals. The knowledge base updater can continuously evolve and improve and thereby generate newer solutions that are updated from previous solutions. After the knowledge base updater has generated the solutions in response to the user request, the knowledge base updater can transmit the solutions to a knowledge base. The knowledge base can function as a memory or data storage on the backend of the system. The knowledge base can be coupled to the knowledge base updater and the processor. LLM and AI/ML algorithms can be incorporated into the solutions as the solutions pass from the knowledge base and back to the processor. The processor can receive the solutions incorporated with the AI to send solutions to the GUI for the user to view and apply.

The processor can then transmit the solutions, which include a preferred solution, a plurality of at least two other viable solutions back to the GUI for the user to view and apply. When the solutions are displayed on the GUI, the user can apply each of the solutions in any order to attempt to resolve the user request. The user may attempt the viable solutions. After applying the viable solutions, the user may receive either a partial resolution or no resolution to the user request. The user can then alert the system using the GUI that the user request has still not been fully resolved. The user can then attempt the preferred solution. After the preferred solution is applied, the user request can be fully resolved. Depending on the type of user request, such as for a price listing or product listing, a full resolution can show a complete listing of products or prices for the user request. The user can alert the system in real-time through the GUI that the user request has been resolved.

The processor on the backend can provide operational insights for the solutions that are provided to the GUI. The operational insights can include the processor determining a resolution effective score for each of the solutions. The resolution effective score can indicate how effective each solution was in resolving the user request. The processor can assign resolution effective scores for the viable solutions that only partially resolve, or do not resolve the user request. The processor can assign the viable solutions resolution scores of less than one hundred percent. When the preferred solution fully resolves the user request, the processor can assign a resolution effective score of one hundred percent to the preferred solution. The resolution effective score of one hundred percent indicates that the user request has been fully resolved. The solution with the highest resolution score can be displayed above the other resolution effective scores on the GUI. Accordingly, the user request can be resolved quickly and efficiently in real-time.

In response to receiving user requests, the computing system can thereby provide efficient and accurate solutions to user requests and significantly reduce the need for user requests to be escalated to call centers or help desk centers. Utilizing lightning web components (LWC), the system allows users to submit queries through an intuitive interface. As users report issues, the system can leverage an Einstein AI processor such as the knowledge base updater to process these inputs, correlate them with relevant historical data, and provide actionable insights in real-time. The GUI can display context-aware suggestions based on the analysis performed by the backend AI engine or knowledge base updater. The knowledge base updater on the backend of the computing system can provide a preferred solution and other viable solutions in response to each user request. In addition, the knowledge base updater can continuously improve and evolve over time. As such, the knowledge base updater can provide improved and updated solutions from previously provided solutions in scheduled intervals. Due to the continuous improvement of the knowledge base updater, incoming user requests can receive updated and improved solutions to apply so that the user requests can be resolved more efficiently.

The system can continuously refine its models by incorporating feedback from multiple sources, including user interactions, solution effectiveness, and error correction logs. The AI engine or knowledge base updater can use reinforcement learning to improve its suggestions, reward solutions that result in successful issue resolution, and adapt its knowledge base over time. This self-learning feedback loop ensures that the system becomes more efficient and accurate as it encounters more real-world scenarios.

As new and improved solutions are provided to user requests, the need to escalate support tickets to a traditional call center or help desk center can be reduced by eighty percent or more. The computing system described above can provide resolutions in a few minutes and in real-time.

The solutions to the present invention described above can apply to a variety of products and solutions. Moreover, due to the advantages described above, the computing system can provide a concise and efficient way for users to receive multiple solutions to user requests in real-time. Further, with the continuous improvement of the knowledge base updater, the computational efficiency of the computing system can improve as well. The computing system can thereby increase the likelihood of providing full resolutions to the majority of user requests that are received through the computing system.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

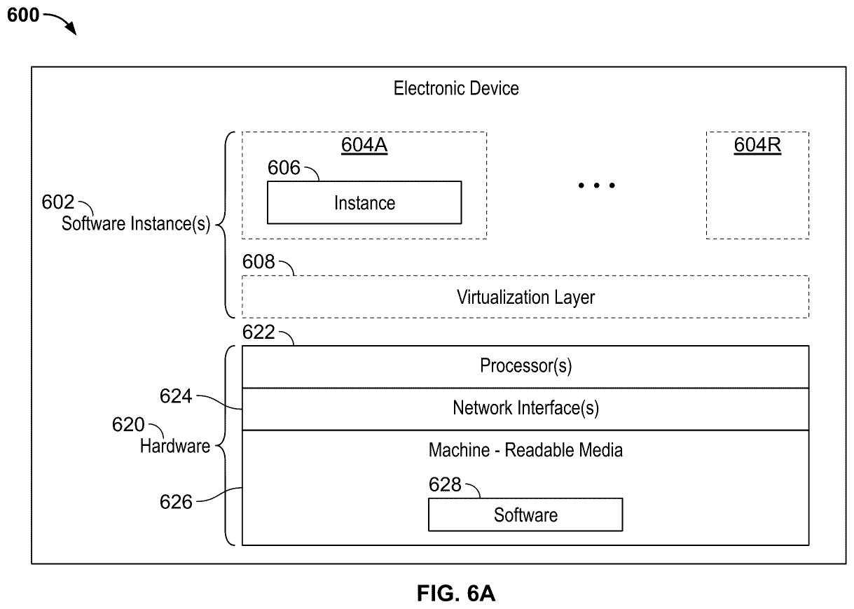

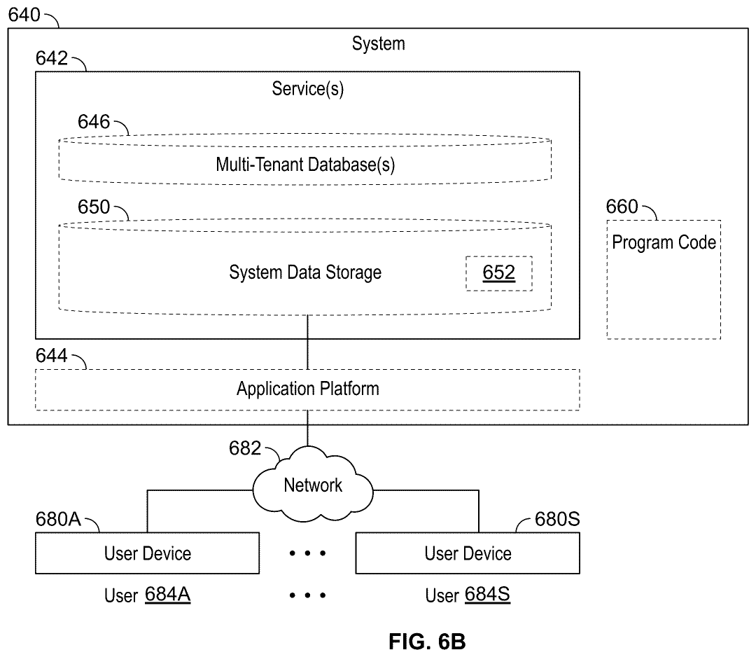

FIG. 6A is a block diagram illustrating an electronic device 600 according to some example implementations that can be used to incorporate the embodiments described above in FIGS. 1-5. FIG. 6A includes hardware 620 comprising a set of one or more processor(s) 622, a set of one or more network interfaces 624 (wireless and/or wired), and machine-readable media 626 having stored therein software 628 (which includes instructions executable by the set of one or more processor(s) 622). The machine-readable media 626 may include non-transitory and/or transitory machine-readable media. Each of the previously described clients, web application firewall services and client-side services may be implemented in one or more electronic devices 600. In one implementation: 1) each of the clients is implemented in a separate one of the electronic devices 600 (e.g., in end user devices where the software 628 represents the software to implement clients to interface directly and/or indirectly with the web application firewall services and/or client-side services (e.g., software 628 represents a web browser, a native client, a portal, a command-line interface, and/or an application programming interface (API) based upon protocols such as Simple Object Access Protocol (SOAP), Representational State Transfer (REST), etc.)); 2) the web application firewall services and/or client-side services is implemented in a separate set of one or more of the electronic devices 600 (e.g., a set of one or more server devices where the software 628 represents the software to implement the web application firewall services and/or client-side services); and 3) in operation, the electronic devices implementing the clients and the web application firewall services and/or client-side services would be communicatively coupled (e.g., by a network) and would establish between them (or through one or more other layers and/or or other services) connections for submitting requests to the web application firewall services and/or client-side services. Other configurations of electronic devices may be used in other implementations.

During operation, an instance of the software 628 (illustrated as instance 606 and referred to as a software instance; and in the more specific case of an application, as an application instance) is executed. In electronic devices that use compute virtualization, the set of one or more processor(s) 622 typically execute software to instantiate a virtualization layer 608 and one or more software container(s) 604A-604R (e.g., with operating system-level virtualization, the virtualization layer 608 may represent a container engine (such as Docker Engine by Docker, Inc. or rkt in Container Linux by Red Hat, Inc.) running on top of (or integrated into) an operating system, and it allows for the creation of multiple software containers 604A-604R (representing separate user space instances and also called virtualization engines, virtual private servers, or jails) that may each be used to execute a set of one or more applications; with full virtualization, the virtualization layer 608 represents a hypervisor (sometimes referred to as a virtual machine monitor (VMM)) or a hypervisor executing on top of a host operating system, and the software containers 604A-604R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 628 is executed within the software container 604A on the virtualization layer 608. In electronic devices where compute virtualization is not used, the instance 606 on top of a host operating system is executed on the “bare metal” electronic device 600. The instantiation of the instance 606, as well as the virtualization layer 608 and software containers 604A-604R if implemented, are collectively referred to as software instance(s) 602.

Alternative implementations of an electronic device may have numerous variations from that described above. For example, customized hardware and/or accelerators might also be used in an electronic device.

Referring to FIG. 6B, with continued reference to FIGS. 1-6A, a block diagram of a deployment environment according to some example implementations described above in FIGS. 1-6A is illustrated. A system 640 includes hardware (e.g., a set of one or more server devices) and software to provide service(s) 642, including web application firewall services and/or client-side services. In some implementations the system 640 is in one or more datacenter(s). These datacenter(s) may be: 1) first party datacenter(s), which are datacenter(s) owned and/or operated by the same entity that provides and/or operates some or all of the software that provides the service(s) 642; and/or 2) third-party datacenter(s), which are datacenter(s) owned and/or operated by one or more different entities than the entity that provides the service(s) 642 (e.g., the different entities may host some or all of the software provided and/or operated by the entity that provides the service(s) 642). For example, third-party datacenters may be owned and/or operated by entities providing public cloud services (e.g., Amazon. com, Inc. (Amazon Web Services), Google LLC (Google Cloud Platform), Microsoft Corporation (Azure)).

The system 640 is coupled to user devices 680A-680S over a network 682. The service(s) 642 may be on-demand services that are made available to one or more of the users 684A-684S working for one or more entities other than the entity which owns and/or operates the on-demand services (those users sometimes referred to as outside users) so that those entities need not be concerned with building and/or maintaining a system, but instead may make use of the service(s) 642 when needed (e.g., when needed by the users 684A-684S). The service(s) 642 may communicate with each other and/or with one or more of the user devices 680A-680S via one or more APIs (e.g., a REST API). In some implementations, the user devices 680A-680S are operated by users 684A-684S, and each may be operated as a client device and/or a server device. In some implementations, one or more of the user devices 680A-680S are separate ones of the electronic device 600 or include one or more features of the electronic device 600.

In some implementations, the system 640 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants. In one implementation, the system 640 is a multi-tenant cloud computing architecture supporting multiple services, such as one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Authorization; Authentication; Security; and Identity and access management (IAM). For example, system 640 may include an application platform 644 that enables PAAS for creating, managing, and executing one or more applications developed by the provider of the application platform 644, users accessing the system 640 via one or more of user devices 680A-680S, or third-party application developers accessing the system 640 via one or more of user devices 680A-680S.

In some implementations, one or more of the service(s) 642 may use one or more multi-tenant databases 646, as well as system data storage 650 for system data 652 accessible to system 640. In certain implementations, the system 640 includes a set of one or more servers that are running on server electronic devices and that are configured to handle requests for any authorized user associated with any tenant (there is no server affinity for a user and/or tenant to a specific server). The user devices 680A-680S communicate with the server(s) of system 640 to request and update tenant-level data and system-level data hosted by system 640, and in response the system 640 (e.g., one or more servers in system 640) automatically may generate one or more Structured Query Language (SQL) statements (e.g., one or more SQL queries) that are designed to access the desired information from the multi-tenant database(s) 646 and/or system data storage 650.

In some implementations, the service(s) 642 are implemented using virtual applications dynamically created at run time responsive to queries from the user devices 680A-680S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 660 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 644 includes an application setup mechanism that supports application developers' creation and management of applications, which may be saved as metadata by save routines. Invocations to such applications, including the web application firewall services and/or client-side services, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 682 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a third Generation Partnership Project (3GPP) protocol, a fourth generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 640 and the user devices 680A-680S.

Each user device 680A-680S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 640. For example, the user interface device can be used to access data and applications hosted by system 640, and to perform searches on stored data, and otherwise allow one or more of users 684A-684S to interact with various GUI pages that may be presented to the one or more of users 684A-684S. User devices 680A-680S might communicate with system 640 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 680A-680S might include an HTTP client, commonly referred to as a “browser,” for sending and receiving HTTP messages to and from server(s) of system 640, thus allowing users 684A-684S of the user devices 680A-680S to access, process and view information, pages and applications available to it from system 640 over network 682.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting. Accordingly, details of the exemplary implementations described above should not be read into the claims absent a clear intention to the contrary.

What is claimed is:

1. A method for providing solutions to a user request, the method comprising:
processing a user request identifying an assigned topic by a processor, wherein the user request is received from a remote graphical user interface (GUI) coupled to the processor;
determining, by an updater coupled to the processor, a plurality of solutions to address the user request with the assigned topic, wherein the plurality of solutions are also determined based on recurring patterns associated with the user request with the assigned topic;
transmitting, by the processor, the plurality of solutions received from the updater to the GUI; and
identifying, by the processor, a resolution effectiveness of the plurality of solutions applied on the GUI.

2. The method of claim 1, further comprising:
providing a preferred solution among the plurality of solutions to the processor to transmit to the GUI.

3. The method of claim 1, further comprising:
providing updates, by the updater, to a memory in periodic intervals, wherein the memory is coupled to the updater and the processor.

4. The method of claim 1, further comprising:
determining, by the processor, if at least one of the solutions provided to the GUI provided a resolution for the user request.

5. The method of claim 1, further comprising:
determining new solutions by the updater to provide to the processor in upcoming intervals.

6. The method of claim 1, further comprising:
determining, by the processor, a resolution effective score for at least one of the solutions provided to the GUI based on whether the at least one solution resolved the user request with the assigned topic on the GUI.

7. The method of claim 1, further comprising:
identifying, by the processor, whether the user request with the assigned topic has to be escalated to other support channels for resolutions based on resolution effective scores of the plurality of solutions.

8. At least one non-transitory machine-readable storage medium that provides instructions that, when executed by at least one processor, are configurable to cause the at least one processor to perform operations comprising:
processing a user request identifying an assigned topic, wherein the user request is received from a remote graphical user interface (GUI) coupled to the at least one processor;
determining a plurality of solutions to address the user request with the assigned topic, wherein the plurality of solutions are also determined based on recurring patterns associated with the user request with the assigned topic;
transmitting the plurality of solutions to the GUI; and
identifying a resolution effectiveness of the plurality of solutions applied on the GUI.

9. The at least one non-transitory machine-readable storage medium of claim 8, wherein the resolution effectiveness of the plurality of solutions enables the at least one processor to determine whether additional support channels are required to address the user request with the assigned topic.

10. The at least one non-transitory machine-readable storage medium of claim 8, wherein the plurality of solutions incorporate a large language model before being transmitted to the GUI.

11. The at least one non-transitory machine-readable storage medium of claim 8, wherein the at least one processor generates updated solutions to be stored in a memory after providing the solutions to the user request.

12. The at least one non-transitory machine-readable storage medium of claim 8, wherein the at least one processor provides an increasing number of new solutions to a memory in periodic intervals.

13. The at least one non-transitory machine-readable storage medium of claim 8, wherein a preferred solution among the plurality of solutions includes a highest resolution effective score among the plurality of solutions provided to the GUI.

14. The non-transitory machine-readable storage medium of claim 8, wherein the at least one processor determines whether at least one of the plurality of solutions resolved the user request before transmitting a support ticket to the GUI.

15. A computing device comprising:
at least one non-transitory machine-readable storage medium that stores software for a dynamic localization service; and
at least one processor, coupled to the at least one non-transitory machine-readable storage medium, to execute the software that implements the dynamic localization service and that is configurable to:
receiving a user request identifying an assigned topic, wherein the user request is received from a remote graphical user interface (GUI) coupled to the at least one processor;
determining a plurality of solutions to address the user request with the assigned topic, wherein the plurality of solutions are also determined based on recurring patterns associated with the user request with the assigned topic;
transmitting the plurality of solutions to the GUI; and
identifying a resolution effectiveness of the plurality of solutions applied on the GUI.

16. The computing device of claim 15, wherein a determination is made on a resolution effective score for a preferred solution among the plurality of solutions after the plurality of solutions are provided to the GUI.

17. The computing device of claim 15, wherein a determination is made that at least one of the solutions provided to the GUI resolved the user request.

18. The computing device of claim 15, wherein additional solutions are provided that are updated from the plurality of solutions transmitted to the GUI.

19. The computing device of claim 15, wherein new solutions in addition to the plurality of solutions are provided in periodic intervals to the storage medium coupled to the at least one processor.

20. The computing device of claim 15, wherein artificial intelligence/machine-learning (AI/ML) algorithms are applied to the plurality of solutions before the plurality of solutions are provided to the GUI.
